(19) United States
(12) Patent Application Publication
(10) Pub. No.: US 2022/0196143 A1
(43) Pub. Date: Jun. 23, 2022

(54) TRANSMISSION HOUSING, SENSOR INSTALLATION KIT AND TRANSMISSION

(71) Applicant: Flender GmbH, 46395 Bocholt (DE)

(72) Inventor: RALF MARTIN DINTER, Gelsenkirchen (DE)

(73) Assignee: Flender GmbH, 46395 Bocholt (DE)

(21) Appl. No.: 17/601,319

(22) PCT Filed: Mar. 13, 2020
(86) PCT No.: PCT/EP2020/056886

§ 371 Date: Oct. 4, 2021

(30) Foreign Application Priority Data
Apr. 5, 2019 (EP) 19167553.7

(51) Int. Cl. F16H 61/00; F16H 57/02

(52) U.S. Cl. CPC F16H 61/0006; F16H 2057/02043; F16H 2057/02026; F16H 57/02

(57) ABSTRACT

A transmission housing includes a lower housing part, and an upper housing part. At least one of the lower and upper housing parts is configured to include on an outside thereof an externally accessible cable accommodating groove.

The invention relates to a transmission housing, a sensor installation kit for installing at least one sensor on such a transmission housing, and a transmission with such a transmission housing and at least one sensor installed on the transmission housing using such a sensor installation kit.

It is known in the prior art to monitor operating parameters of transmission components with suitable sensors. Monitoring the temperature of transmission bearings using suitable temperature sensors should be mentioned here by way of example. For this purpose, the temperature sensors need to be positioned close to the transmission bearings and the sensor cables need to be laid inside the transmission housing using cable tubes, routed out of said housing, and then connected to a sensor gateway or the like. The installation accordingly entails a large amount of time and high costs.

A device for measuring forces on a wind turbine is known from EP 3 460 236 A1, in which sensor cables run on a support bolt instead, according to the invention, along a groove on the transmission housing.

Starting from this prior art, an object of the present invention is to configure the installation of sensors on transmissions in a simple and cost-effective manner.

In order to achieve this object, the present invention provides a transmission housing which is characterized in that it is provided on its outside with at least one externally accessible cable accommodating groove. In such a cable accommodating groove which advantageously extends along those positions at which sensors are to be positioned, sensor cables can be laid from outside in a simple manner such that it is possible to dispense completely with the use of cable tubes which run inside the housing. Sensors can accordingly be installed cost-effectively on the transmission.

The at least one cable accommodating groove is advantageously produced using casting technology. There is hence no need to machine the transmission housing in order to form the at least one cable accommodating groove, as a result of which further costs can be saved.

The at least one cable accommodating groove preferably has a square or rectangular cross-section which results in a simple structure and is also conducive to simple laying of the sensor cables.

According to an embodiment of the present invention, the transmission housing is provided on its outside with at least one externally accessible recess into which the at least one cable accommodating groove opens and which is designed to accommodate at least one electronic component, for example to accommodate a wirelessly transmitting sensor gateway. Simple installation of the electronic components is accordingly also ensured.

At least one preferably cylindrically formed sensor introduction duct is advantageously provided which extends inward starting from the base of the cable accommodating groove and is in particular produced using casting technology. The sensor introduction duct predetermines the later position of a sensor to be installed.

A sensor accommodating duct in the form of a bore, which can be provided with an internal thread, preferably adjoins the sensor introduction duct. In other words, the sensor accommodating duct which is intended to ultimately accommodate the sensor is produced by machining, starting from the sensor introduction duct. This makes possible very precise manufacturing of the sensor accommodating duct and hence very precise positioning of the sensor when it is installed.

In order to achieve the object mentioned at the beginning, the present invention moreover provides a sensor installation kit for installing at least one sensor on a transmission housing according to the invention, comprising at least one sensor, at least one sensor cable connected to the sensor, and a plurality of cable accommodating groove cover elements, the external dimensions of which are adapted to the cable accommodating groove provided on the transmission housing in such a way that the cable accommodating groove can be covered by them. Sensors can be installed simply on the transmission housing according to the invention using such a sensor installation kit by the sensors being installed at the position provided, the associated sensor cables being arranged in the at least one cable accommodating groove, and the cable accommodating groove then being covered or closed by the cable accommodating groove cover elements.

According to an embodiment of the present invention, the at least one sensor is accommodated watertightly inside a sensor accommodating sleeve with a cuplike form and a cylindrical outer periphery, wherein the sensor cable connected to the sensor is routed out of the sensor accommodating sleeve on a first side. By virtue of such a sensor accommodating sleeve, the sensor is, on the one hand, protected from external influences and hence damage. On the other hand, a sensor accommodating sleeve having defined dimensions can be positioned much more precisely and can be installed more simply than a sensor alone. A sensor accommodating sleeve can be inserted readily in a sensor accommodating duct, designed as a bore, of the transmission housing and can, for example, be bonded or pressed into place. The sensor accommodating sleeve can be produced from metal or plastic, in particular from a thermally conductive plastic when the sensor is a temperature sensor. The second side of the sensor accommodating sleeve is preferably designed in the form of a conically tapering tip in a similar fashion to the sensor accommodating duct, when the latter is configured as a bond bore, as a result of which good heat transfer can be ensured.

The sensor accommodating sleeve can be provided along its outer periphery with a sealing ring accommodating groove into which a sealing ring is inserted in order to ensure watertight installation of the sensor accommodating sleeve on the transmission housing.

According to an embodiment of the present invention, the sensor accommodating sleeve is provided with an external thread, wherein a screwdriver accommodating recess is formed on the first side of the sensor accommodating sleeve. The sensor accommodating sleeve is accordingly screwed to the transmission housing. For this purpose, the sensor accommodating recess can be configured with a corresponding internal thread.

A plurality of sensors are advantageously provided to which sensor cables of different lengths are connected, for example previously defined lengths of 1, 2, 3, 4, or 5 m. Depending on the desired position of the sensor on the transmission housing, a sensor with a sensor cable of a suitable length can then be chosen. Excess sensor cable can be readily stored in the cable accommodating groove of the transmission housing. By virtue of such sensors with different sensor cable lengths, there is no need to cut the sensor cable to length, as a result of which time can be saved during the installation and errors in the installation can be avoided.

Cable accommodating groove cover elements which extend in a straight line are preferably provided which are designed to cover sections of the cable accommodating groove of the transmission housing which extend in a straight line.

According to an embodiment of the present invention, viewed in cross-section, the straight cable accommodating groove cover elements comprise two sidewall limbs extending perpendicular and parallel to each other, a base limb extending horizontally and connecting the latter to each other at their lower free ends, a cover limb which extends parallel to the base limb, is connected on its underside to the other free end of the first sidewall limb, and projects laterally beyond the two sidewall limbs, and a third sidewall limb which is connected to the underside of the cover limb, extends downward from the latter, and bears against the outside of the second sidewall limb. In other words, the cable accommodating groove cover elements extending in a straight line define a cable duct which is closed at the top by the laterally projecting cover limb and can be bent open laterally in order to arrange a sensor cable therein.

In addition to linear cable accommodating groove cover elements, L-shaped or curved cable accommodating groove cover elements are advantageously provided which are designed to cover corresponding L-shaped or curved sections of the cable accommodating groove. The L-shaped or curved cable accommodating groove cover elements can also define a cable duct into which a sensor cable can be laid or pushed.

The cable accommodating groove cover elements are advantageously provided at their outer periphery with laterally projecting lips via which frictional assembly and/or sealing is effected with respect to the sidewalls of the cable accommodating groove of the transmission housing.

The sensor installation kit preferably has at least one electronic component, in particular in the form of a wirelessly transmitting sensor gateway, the dimensions of the recess of the transmission housing being adapted to the external dimensions of the latter.

The sensor installation kit advantageously has a cover for covering the recess of the transmission housing, which can be provided with laterally projecting lips.

In order to achieve the object mentioned at the beginning, the present invention moreover provides a transmission with a transmission housing according to the invention and at least one sensor installed on the transmission housing using a sensor installation kit according to the invention.

Further advantages and features of the present invention will become clear with the aid of the following description and with reference to the attached drawings, in which:

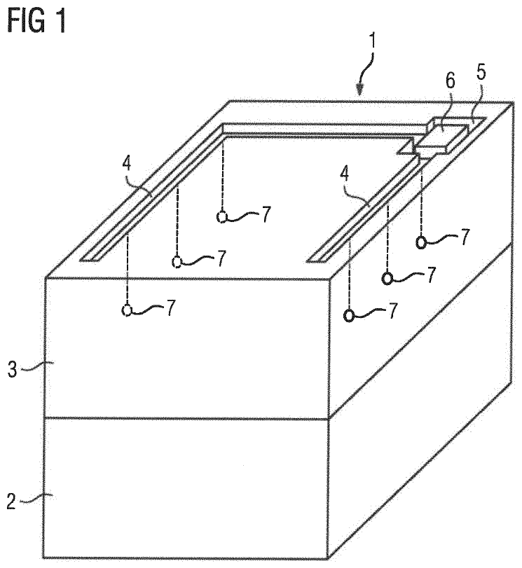

FIG. 1 shows a schematic view of a transmission housing according to an embodiment of the present invention which is provided with a plurality of sensors;

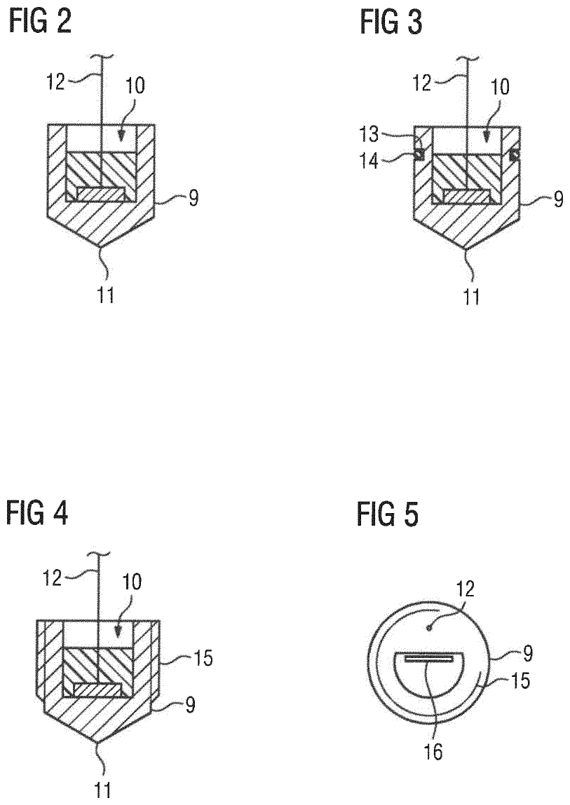

FIG. 2 shows a schematic view in section of an example of a sensor of a sensor installation kit according to an embodiment of the present invention;

FIG. 3 shows a schematic view in section of a further example of a sensor of a sensor installation kit according to an embodiment of the present invention;

FIG. 4 shows a schematic view in section of yet another example of a sensor of a sensor installation kit according to an embodiment of the present invention;

FIG. 5 shows a plan view of the sensor shown in FIG. 4;

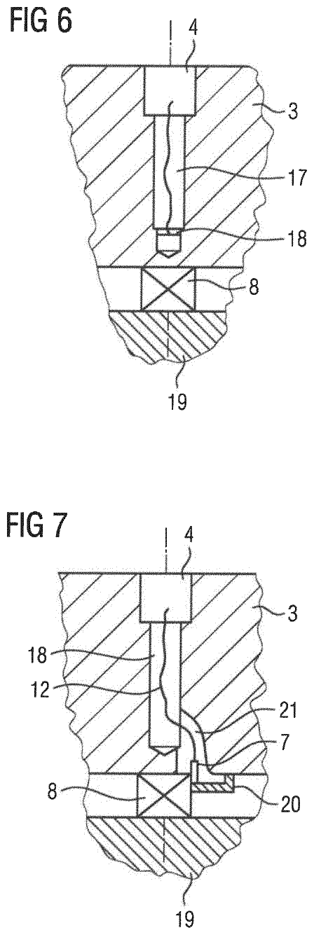

FIG. 6 shows a view in section of the transmission housing shown in FIG. 1 which shows a first possible positioning of a sensor;

FIG. 7 shows a further view in section of the transmission housing shown in FIG. 1 which shows a second possible positioning of a sensor;

FIG. 8 shows yet another view in section of the transmission housing shown in FIG. 1 which shows a third possible positioning of a sensor;

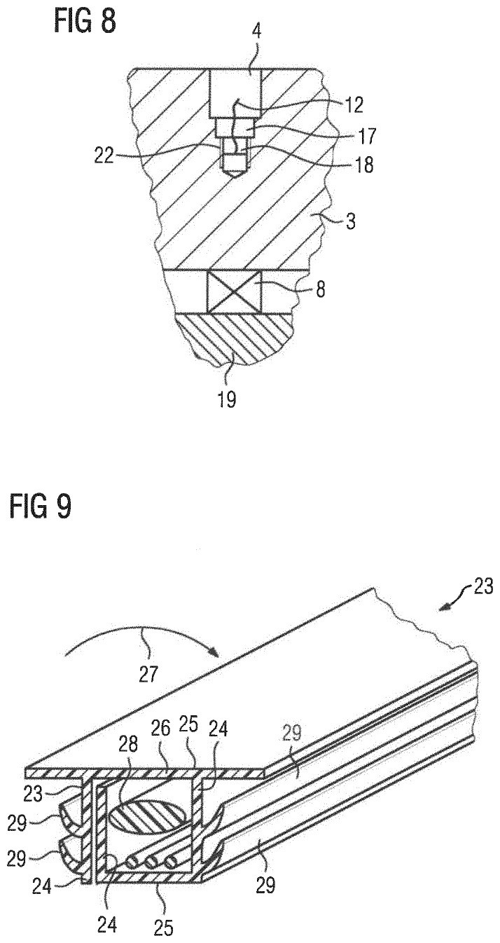

FIG. 9 shows a schematic partial view of a straight cable accommodating groove cover element of a sensor installation kit according to an embodiment of the present invention;

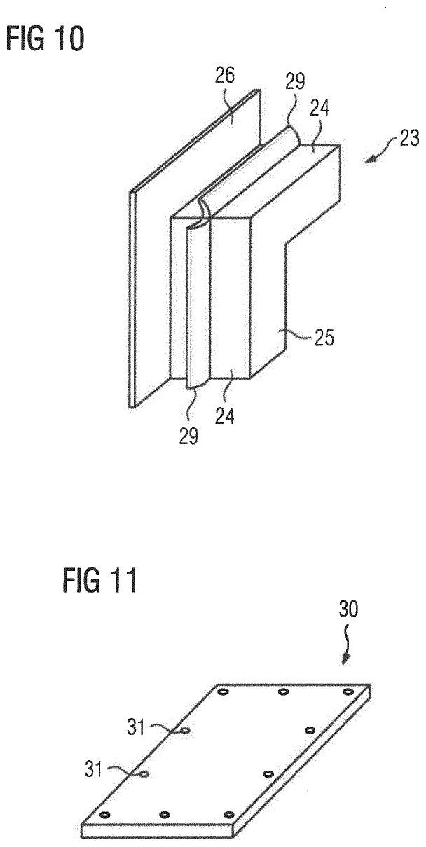

FIG. 10 shows a schematic view of an L-shaped cable accommodating groove cover element of a sensor installation kit according to an embodiment of the present invention;

FIG. 11 shows a view of a first alternative embodiment of a covering of a sensor installation kit according to an embodiment of the present invention; and

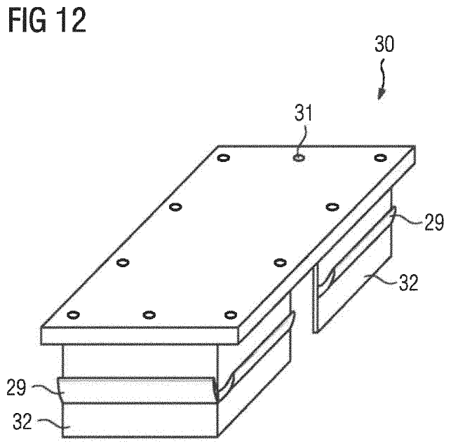

FIG. 12 shows a view of a second alternative embodiment of a covering of a sensor installation kit according to an embodiment of the present invention.

The same reference numerals refer below to the same or similarly formed component areas.

FIG. 1 schematically shows a transmission housing 1 according to an embodiment of the present invention which, in the present case, is divided into a lower housing part 2 and an upper housing part 3. The transmission housing 1 is provided on its outside with externally accessible cable accommodating grooves 4 which, in the present case, have a square cross-section. However, other cross-sections are in principle also conceivable, in particular rectangular cross-sections, The cable accommodating grooves 4 open out in a recess 5 which is likewise provided on the outside of the transmission housing 1 and is externally accessible. The recess 5 serves to accommodate an electronic component 6 which, in the present case, is formed by a sensor gateway which is designed to transmit signal data detected by sensors wirelessly to a data evaluation unit (not shown in detail). The cable accommodating grooves 4 and the recess 5 are produced together with the transmission housing 1, using casting technology. However, it is also possible in principle to introduce the cable accommodating groove 4 and the recess 5 subsequently using machining or other manufacturing methods.

Sensors 7, which are shown only schematically in FIG. 1, are provided in order to monitor transmission components arranged inside the transmission housing 1. In the present case, the sensors 7 monitor the temperature of bearings 8 arranged inside the transmission housing 1, which is why they are designed as temperature sensors. However, it should in principle be dear that the type of sensors 7 can be chosen freely depending on the operating parameters to be monitored. The sensors 7 can thus also be acceleration sensors and/or vibration sensors. According to an embodiment of the present invention, the sensors 7 are accommodated watertightly inside a sensor accommodating sleeve 9 with a cuplike form and a cylindrical outer periphery, which in the present case is preferably produced from a material which is a good conductor of heat, for example from metal or a thermally conductive plastic. Different alternative embodiments of such a sensor accommodating sleeve 9 are shown in FIGS. 2 to 5. FIG. 2 shows a sensor accommodating sleeve 9 which defines a sensor accommodating space 10 which can be accessed axially from a side of the sensor accommodating sleeve 9. The opposite end is provided with a conically tapering tip 11. The sensor 7 is inserted into the sensor accommodating space 10, wherein a sensor cable 12 connected to the sensor is routed out of the sensor accommodating space 10. The sensor 7 is encapsulated in the sensor accommodating space 10, for example using a resin which is advantageously a good conductor of heat, such that it is retained rigidly on the sensor accommodating sleeve 9. FIG. 3 shows a sensor accommodating sleeve 9 with a sensor 7 arranged thereon which differs from the alternative embodiment shown in FIG. 2 in that the sleeve 9 is provided along its outer periphery with a sealing ring accommodating groove 13 into which a sealing ring 14 is inserted. The alternative embodiment shown in FIG. 4 differs from the alternative embodiment shown in FIG. 2 in that the sensor accommodating sleeve 9 is provided with an external thread 15, and in that a screwdriver accommodating recess 16 is formed on the upper side of the sensor accommodating sleeve 9 in order to manipulate the sensor accommodating sleeve 9 in the manner of a screw. It should be clear that other suitable tool accommodating recesses can also be provided.

Possible installation situations of sensors 7 and sensor accommodating sleeves are shown in FIGS. 6 to 8.

Starting from one of the cable accommodating grooves 4, shown in FIG. 1, of the transmission housing 1, according to FIG. 6 a sensor introduction duct 17, with a cylindrical form in the present case, is provided which is preferably likewise produced, like the cable accommodating groove 4, together with the transmission housing 1 using casting technology. A sensor accommodating duct 18 in the form of a bore, which in the present case is designed as a blind bore, adjoins the sensor introduction duct 17. The sensor accommodating duct 18 ends shortly above a bearing 8 arranged on a shaft 19 inside the transmission housing 1. A sensor 7, which in the present case is positioned in a sensor accommodating sleeve 9 according to the alternative embodiment shown in FIG. 2, is arranged in the sensor accommodating duct 18. The shape of the tip 11 of the sensor accommodating sleeve is advantageously adapted to the shape of the tip of the sensor accommodating duct 18 such that the tip 11 bears flat against the transmission housing 1. Optimal contact between the tip 11 of the sensor accommodating sleeve 9 and the transmission housing 1 can be achieved, for example, using an adhesive which is a good conductor of heat or a thermal contact paste. The sensor cable 12 is routed upward through the sensor introduction duct 17 to the cable accommodating groove 4 and through the cable accommodating groove 4 to the electronic component 6 to which it is connected.

In the alternative embodiment shown in FIG. 7, a sensor accommodating duct 18, which is likewise designed as a blind bore, leads downward, starting from the cable accommodating groove 4, and ends shortly before a bearing 8 which is arranged inside the transmission housing 1 and is secured axially in a manner known per se via a retaining ring 20. The position of the sensor accommodating duct 18 is chosen in the present case in such a way that access to the bearing 8 is provided in the lower region of the sensor accommodating duct 18 via a housing duct 21. A sensor 7 is positioned directly on the bearing 8 through this housing duct 21. The sensor cable 12 is routed upward through the housing duct 21 and the sensor accommodating duct 18, into the cable accommodating groove 4. From there it is laid in the cable accommodating groove 4 so that it leads to the electronic component 6 to which it is connected.

According to FIG. 6, a sensor introduction duct 17 to which a sensor accommodating duct 18, which in the present case is designed as a blind bore and is provided with an internal thread 21, is connected extends downward, starting from the cable accommodating groove 4. The external thread 15 of the arrangement shown in FIGS. 4 and 5 is screwed into the internal thread 21. The sensor cable 12 is also routed here through the sensor accommodating duct 18, the sensor introduction duct 17, and the cable accommodating groove 4, to the electronic component 6 to which it is connected.

A plurality of cable accommodating groove cover elements 23, which in the present case comprise cable accommodating groove cover elements 23, extending in a straight line, according to FIG. 9, and L-shaped cable accommodating groove cover elements 23, according to FIG. 10, are provided for the purpose of covering the cable accommodating groove 4.

The cable cover element 23 shown in FIG. 9 has, viewed in cross-section , two sidewall limbs 24 extending perpendicular and parallel to each other, a base limb 25 extending horizontally and connecting the latter to each other at their lower free ends, a cover limb 26 which extends parallel to the base limb 25, is connected at its underside to the other free end of the first sidewall limb 24, and projects laterally beyond the two sidewalls 24, and a third sidewall limb 24 which is connected to the underside of the cover limb 26, extends downward from the latter, and bears against the outside of the second sidewall limb 24. The sidewall limbs 24 form, together with the base limb 25, a sensor cable accommodating duct which is covered by the cover limb 26. The cable accommodating groove cover element 23 is produced from an elastic material, in particular from an elastic plastic or from a rubber-like material, such that the sensor cable can be bent elastically in the direction of the arrow 27 in order to be able to position the sensor cables 12 in the sensor cable duct. The sensor cables 12 can be secured inside this sensor cable duct using a strip-like insert 28 which can be produced, for example, from foam. The dimensions of the insert 28 are here chosen in such a way that, when the insert 28 is pressed into the sensor cable duct, a form fit results with the adjacent sidewall limbs 24 of the cable accommodating groove cover element 23. Lips 29 which in the present case project laterally outward are provided on the outer two sidewall limbs 24 and serve to allow the cable accommodating groove cover element 23 to be inserted from above in a form-fitting fashion and/or watertightly into a section, extending in a straight line, of the cable accommodating groove 4 of the transmission housing 1. The laterally projecting undersides of the cover limb 26 can be bonded to the surface of the transmission housing 1 in order to secure the cable accommodating groove cover element 23 on the transmission housing 1 and/or to obtain a watertight connection.

FIG. 10 shows an L-shaped cable accommodating groove cover element 23 which serves to be inserted in the corner region of the cable accommodating groove 4 shown in FIG. 1. The structure corresponds in principle to the cable accommodating groove cover element 23 shown in FIG. 9.

FIG. 11 shows a cover which is designed to cover the recess 5 provided on the transmission housing 1 and has corresponding dimensions. The cover 30 is designed in the present case as a metal plate and provided with through holes 31 which serve to accommodate fastening screws (not shown in detail) in order to screw the cover 30 to threaded bores (likewise not shown in detail) of the transmission housing 1. The cover 30 can be provided on its underside with a seal in order to obtain a watertight cover of the recess 5.

FIG. 12 shows a further alternative embodiment of a cover 30 for covering the recess 5 of the transmission housing 1. The cover 30 shown in FIG. 12 is produced from plastic and comprises a cover plate 32 from which walls 33, provided with lips 30, extend downward, the position of the walls being chosen in such a way that they engage with the walls of the recess 5 when the cover 30 is pressed from above into the recess 5. The underside of the cover plate can be bonded to the outer face of the transmission housing as soon as the cover 30 is inserted into the recess 5 in order to obtain a secure fastening and, if required, a watertight or splash-proof arrangement.

The sensors 7 accommodated in the sensor accommodating sleeve 9, the cable accommodating groove cover elements, and the covers advantageously form constituents of a sensor installation kit according to the invention.

Although the invention has been illustrated and described in detail by the preferred exemplary embodiment, the invention is not limited by the disclosed examples and other variants can be derived by a person skilled in the art without going beyond the protective scope of the invention.

1.-18. (canceled)

19. A transmission housing, comprising:
a lower housing part; and
an upper housing part,
at least one of the lower and upper housing parts being configured to include on an outside thereof an externally accessible cable accommodating groove.

20. The transmission housing of claim 19, wherein the cable accommodating groove is produced using casting technology.

21. The transmission housing of claim 19, wherein the cable accommodating groove has a square or rectangular cross-section.

22. The transmission housing of claim 19, wherein the at least one of the lower and upper housing parts has the outside an externally accessible recess into which the cable accommodating groove opens and which is designed to accommodate an electronic component.

23. The transmission housing of claim 19, wherein the at least one of the lower and upper housing parts has a first sensor introduction duct which extends inward from a base of the cable accommodating groove.

24. The transmission housing of claim 23, wherein the at least one of the lower and upper housing parts has a second sensor accommodating duct which adjoins the first sensor introduction duct and is configured in the form of a bore which can be provided with an internal thread.

25. A sensor installation kit, comprising:
a sensor;
a sensor cable connected to the sensor for placement in a cable accommodating groove on an outside of a transmission housing; and
a plurality of cable accommodating groove cover elements having external dimensions which are adapted to the cable accommodating groove for covering the cable accommodating groove.

26. The sensor installation kit of claim 25, further comprising a sensor accommodating sleeve configured to accommodate therein the sensor watertightly, said sensor accommodating sleeve having a cuplike form and a cylindrical outer periphery, said sensor cable being routed out of the sensor accommodating sleeve on a first side of the sensor accommodating sleeve.

27. The sensor installation kit of claim 26, wherein the sensor accommodating sleeve is provided along the outer periphery with a sealing ring accommodating groove, and further comprising a sealing ring inserted in the sealing ring accommodating groove.

28. The sensor installation kit of claim 26, wherein the sensor accommodating sleeve is provided with an external thread and formed with a screwdriver or tool accommodating recess on the first side of the sensor accommodating sleeve.

29. The sensor installation kit of claim 25, further comprising a plurality of said sensor and a plurality of said sensor cable, said sensor cables having different lengths for connection to the sensors.

30. The sensor installation kit of claim 25, wherein the cable accommodating groove cover elements extend in a straight line.

31. The sensor installation kit of claim 30, wherein, viewed in cross-section, the straight cable accommodating groove cover elements comprise first and second sidewall limbs extending perpendicular and parallel to each other, a base limb extending horizontally and connecting the first and second sidewall limbs to each other at their lower free ends, a cover limb which extends parallel to the base limb and connects on an underside to another free end of the first sidewall limb, and is sized to project laterally beyond the first and second sidewall limbs, and a third sidewall limb which is connected to the underside of the cover limb and extends downward from the cover limb and which bears against an outside of the second sidewall limb.

32. The sensor installation kit of claim 25, wherein the cable accommodating groove cover elements have an L-shaped or curved configuration.

33. The sensor installation kit of claim 25, wherein the cable accommodating groove cover elements are provided at an outer periphery with laterally projecting lips.

34. The sensor installation kit of claim 25, further comprising an electronic component having an external dimension which is adapted to a dimension of a recess of the transmission housing.

35. The sensor installation kit of claim 34, further comprising a cover for covering the recess of the transmission housing, said cover provided with laterally projecting lips.

36. The sensor installation kit of claim 25, wherein the sensor accommodating sleeve has a second side designed in the form of a conically tapering tip.

37. The sensor installation kit of claim 34, wherein the electronic component is designed in the form of a wirelessly transmitting sensor gateway.

38. A transmission, comprising:
a transmission housing comprising a lower housing part, and an upper housing part, at least one of the lower and upper housing parts being configured to include on an outside thereof an externally accessible cable accommodating groove; and
a sensor installation kit comprising a sensor, a sensor cable connected to the sensor for placement in the cable accommodating groove of the transmission housing, and a plurality of cable accommodating groove cover elements having external dimensions which are adapted to the cable accommodating groove for covering the cable accommodating groove.
